(19) United States
(12) Patent Application Publication
(10) Pub. No.: US 2002/0156592 A1
(43) Pub. Date: Oct. 24, 2002

(54) Optical pulse reconstruction from sonogram

(76) Inventors: Kenji Taira, Tokyo (JP); Kazuro Kikuchi, Kanagawa (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/090,082

(22) Filed: Mar. 1, 2002

Related U.S. Application Data
(60) Provisional application No. 60/272,888, filed on Mar. 2, 2001.

(51) Int. Cl. G06F 19/00

(52) U.S. Cl. 702/66

(57) ABSTRACT

This invention relates to an optical pulse reconstruction from sonogram. According to the present invention, there is provided a method for measuring an optical pulse which comprises: filtering an optical pulse to obtain a frequency-filtered pulse, a transfer or window function for said frequency filtering being given; measuring a sonogram, which is defined as the intensity waveform of said frequency-filtered pulse, to obtain a measured sonogram; and reconstructing said optical pulse by using said measured sonogram and said transfer or window function. The present invention also provides a formula for retrieving the amplitude and phase of an optical pulse from its sonogram. When the transfer function of the frequency filter is known, the pulse amplitude and phase are completely retrieved from the sonogram without iterative calculations by derived formula.

### RELATED APPPLICATION

This application claims the benefit of U.S. provisional application Serial No. 60/272,888, filed Mar. 2,2001, the benefit of which is hereby claimed under 35 U.S.C 119.

### FIELD OF THE INVENTION

This invention relates to an optical pulse reconstruction from sonogram, and more particularly, to a method for measuring the optical pulse from its sonogram and an optical sampling system employing the same.

### BACKGROUND OF THE INVENTION

Frequency-resolved optical gating (FROG) is most commonly used to measure the amplitude and phase of ultra-short optical pulses. In the FROG system, we measure the spectrogram, which is the field spectrum of an optical pulse under test temporarily gated by itself. Nonlinear optical materials are employed for such optical gating. Though the window function for optical gating is unknown, the amplitude and phase of the pulse are retrieved from the measured spectrogram by an iterative minimization algorithm.

An alternative approach is the sonogram characterization method. In this measurement, after a pulse is frequency-filtered, the intensity waveform of the filtered pulse is measured by a cross-correlator which is based on optical mixing using nonlinear optical materials or two-photon absorption in photodiodes and semiconductor lasers. It is shown in D. T. Reid (“Algorithm for complete and rapid retrieved of ultrashort pulse amplitude and phase from a sonogram,” IEEE J. Quantum Electron. vol. 35, pp. 1584-1589, Nov. 1999) that an iterative algorithm similar to that used in the FROG system, in which the window function for frequency filtering is assumed to be unknown, can be employed for pulse reconstruction from the sonogram.

According to the algorithm proposed in above-mentioned article, however, time-consuming iterative calculations are indispensable for pulse reconstruction from the sonogram.

An object of the present invention is to retrieve the amplitude and phase of an optical pulse from its sonogram without iterative calculations.

Another object of the present invention is to provide rapid pulse retrieval from the sonogram.

Still another object of the present invention is to enable us to discuss the sampling pulse width required to reconstruct the pulse accurately.

Still another object of the present invention is to provide a formula for accomplishing the above-mentioned objects.

### SUMMARY OF THE INVENTION

According to the present invention, there is provided a method for measuring an optical pulse which comprises: filtering an optical pulse to obtain a frequency-filtered pulse, a transfer or window function for said frequency filtering being given; measuring a sonogram, which is defined as the intensity waveform of said frequency-filtered pulse, to obtain a measured sonogram; and reconstructing said optical pulse by using said measured sonogram and said transfer or window function.

The present invention also provides a formula for retrieving the amplitude and phase of an optical pulse from its sonogram. When the transfer function of the frequency filter is known, the pulse amplitude and phase are completely retrieved from the sonogram without iterative calculations by derived formula. The pulse reconstruction formula is practically important for rapid pulse retrieval from the sonogram. More importantly, it enables us to discuss the sampling pulse width required to reconstruct the pulse accurately.

The present invention also relates to an optical sampling system including the sonogram characterization function.

### BRIEF DESCRIPTION OF THE DRAWINGS

The foregoing aspects and many of the attendant advantages of this invention will become more readily appreciated as the same become better understood by reference to the following detailed descriptions, when taken in conjunction with the accompanying drawings, wherein:

FIG. 1 shows experimental setups for measuring the sonogram in which the sampling pulse, which is synchronized with the pulse under test and has a width narrower than that of the pulse under test, is prepared;

FIG. 2 shows experimental setups for measuring the sonogram in which the sampling pulse is the same as the signal pulse under test;

FIG. 3 shows a modified process for pulse reconstruction from the sonogram obtained in FIG. 2;

FIG. 4A shows optical sampling systems including the sonogram characterization function in which the sampling pulse is obtained by compressing the signal pulse under test;

FIG. 4B shows optical sampling systems including the sonogram characterization function in which the sampling pulse is incident on the device under test (DUT), and the impulse response of the DUT is characterized from the sonogram;

FIG. 5 shows experimental setups for the optical sampling system having the sonogram characterization function;

FIG. 6 shows the measured transfer function of the bandpass filter for frequency gating;

FIG. 7 shows the sonogram of the output pulse from the bandpass filter under test;

FIG. 8 shows the intensity waveform and phase of the output pulse reconstructed from the sonogram;

FIG. 9A shows the auto-correlation trace and spectrum in which circles show those calculated from the reconstructed pulse, and solid curves are directly measured ones; and

FIG. 9B shows the auto-correlation trace of the signal pulse in which circles show those calculated from the reconstructed pulse, and solid curves are directly measured ones.

### DETAILED DESCRIPTION OF THE PREFERRED EMBODIMENT

### I. Sonogram Measurement

In the sonogram measurement, after a pulse is frequency-filtered, the intensity waveform of the filtered pulse is measured by a cross-correlator which is based on optical mixing using nonlinear optical materials or two-photon absorption in photodiodes and semiconductor lasers.

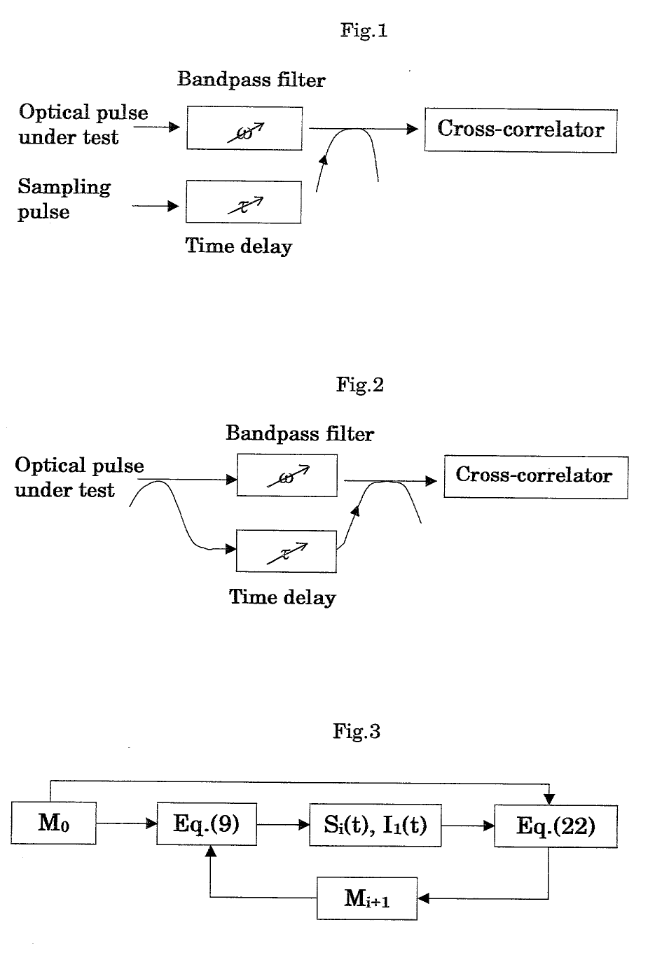

In the sonogram measurement, we have freedom to choose a sampling pulse width for cross-correlation. Two extreme cases are shown in FIGS. 1 and 2. In FIG. 1, we prepare a sampling pulse, which has a pulse width narrower than that of the pulse under test and is highly synchronized with the pulse under test. After the pulse under test is frequency-filtered, it is cross-correlated with the sampling pulse in order to measure the intensity waveform of the frequency-filtered pulse. In this case, we can determine the sonogram precisely as long as the sampling pulse width is short enough.

On the other hand, in FIG. 2, the pulse under test is divided into two replicas. One of the replicas is frequency-filtered and then cross-correlated with the other. However, the sonogram thus obtained is not an actual one because the temporal resolution is limited by the shape of the pulse under test.

### II. Pulse Reconstruction Formula

We first derive a formula for retrieving the pulse under test from its sonogram. In contrast to the sonogram characterization of the prior art, we assume that the window function for frequency filtering is given. In such a case, the pulse amplitude and phase are completely retrieved from the sonogram without iterative calculations by using the derived formula.

Let the complex amplitude of the signal pulse under test be s(τ). When the signal pulse is frequency-filtered by a band pass filter whose transfer function is H(ω), the complex amplitude of the output pulse is given as

$${s}_{ω} ( t ) = \frac{1}{\sqrt{2 π}} \int exp ( {jω}^{′} t ) S ( {ω}^{′} ) H ( ω - {ω}^{′} ) ⅆ {ω}^{′} , \qquad ( 1 )$$

where S(ω) is the Fourier transform of s(τ). The sonogram is defied as the intensity waveform of the frequency-filtered pulse:

G(ω.t)=|S₁₀₇(t)|^{2.} (2)

We next discuss how we retrieve s(τ) from G(ω, t), closely following the method described in L. Cohen, “Time-Frequency Distributions—A Review,” Proc. IEEE., vol. 77, no. 7, pp 941-981, 1989.

The characteristic function M(θ, τ) of the sonogram G(ω, t) is defied as

M(θ.τ)=∫∫G(ω. t)exp(jθt+jτω)dtdω . (3)

On the other hand, the ambiguity function for the signal is defined as

$${A}_{s} ( θ , τ ) = \int {s}^{*} ( t - \frac{1}{2} τ ) s ( t + \frac{1}{2} τ ) exp ( j θ t ) ⅆ t . \qquad ( 4 )$$

If the inverse Fourier transform of H(ω) is h(t), given as

$$h ( t ) = \frac{1}{\sqrt{2 π}} \int H ( ω ) exp ( jω t ) ⅆ ω , \qquad ( 5 )$$

the ambiguity function of h(t) is similarly expressed as

$${A}_{h} ( θ , τ ) = \int {h}^{*} ( t - \frac{1}{2} τ ) h ( t + \frac{1}{2} τ ) exp ( j θ t ) ⅆ t . \qquad ( 6 )$$

Then, the characteristic function M(θ, τ), defined by (3) can be expressed in terms of these ambiguity functions as

M(θ, τ)=Aₛ(θ, τ)Aₕ(−θ, τ). (7)

From (4), we have

$${s}^{*} ( t - \frac{1}{2} τ ) s ( t + \frac{1}{2} τ ) = \frac{1}{2 π} \int {A}_{s} ( θ , τ ) exp ( - j θ t ) ⅆ θ . \qquad ( 8 )$$

By letting t=τ/2 in (8) and substituting (7) into (8), we obtain the following pulse reconstruction formula:

$$s ( t ) = \frac{1}{2 π {s}^{*} ( 0 )} \int \frac{M ( θ \cdot t )}{{A}_{h} ( - θ , t )} exp ( - j θ t / 2 ) ⅆ θ . \qquad ( 9 )$$

We find that when the transfer function H(co) of the filter is given, the complex amplitude s(t) of the pulse is completely retrieved from the measured sonogram G(ω, t) by using (3),(5),(6), and (9).

On the other hand, Reid discusses an algorithm for pulse reconstruction from the sonogram based on iterative calculations, where it is assumed that s(t) and H(ω) are unknown. The pulse reconstructed from the sonogram by this algorithm should be the same as that given by (9). However, once the transfer function of the filter H(ω) is given, we can retrieve the pulse amplitude and phase very rapidly without using iterative calculations. Such experiment was actually demonstrated and will be discussed later.

III. Limit of Sonogram Characterization of Optical Pulses

### [A] Requirement for the Filtering Bandwidth

We discuss requirements for the bandwidth of the filter based on the pulse reconstruction formula (9).

We assume a chirped Gaussian pulse for the pulse under test:

$$s ( t ) = exp [ - \frac{{t}^{2}}{2} ( 1 + j C ) ] , \qquad ( 10 )$$

where the time is normalized to the pulse width parameter, and C is the chirp parameter. We also assume the transfer function of the filter having a Gaussian distribution:

$$H ( ω ) = exp [ - \frac{{ω}^{2}}{2 {ω}_{0}^{2}} ] . \qquad ( 11 )$$

By using these Gaussian functions and (1), (2) and (3), the real sonogram G(ω, t) and its characteristic function M(θ, τ) can be expressed in the following analytical forms:

$$\begin{matrix}\begin{matrix}G ( ω , t ) = exp [ - \frac{{ω}_{0}^{2} {t}^{2} ( 1 + {ω}_{0}^{2} + {C}^{2} )}{{( {ω}_{0}^{2} + 1 )}^{2} + {C}^{2}} ] \times \\ exp [ - \frac{2 C {ω}_{0}^{2} t ω}{{( {ω}_{0}^{2} + 1 )}^{2} + {C}^{2}} ] \times \\ exp [ - \frac{{ω}^{2} ( 1 + {ω}_{0}^{2} )}{{( {ω}_{0}^{2} + 1 )}^{2} + {C}^{2}} ] ,\end{matrix} & ( 12 ) \\ \begin{matrix}M ( θ , τ ) = exp [ - \frac{{τ}^{2} ( 1 + {ω}_{0}^{2} + {C}^{2} )}{4} ] \times \\ exp [ - \frac{C θτ}{2} ] \times exp [ - \frac{{θ}^{2} ( 1 + {ω}_{0}^{2} )}{4 {ω}_{0}^{2}} ] .\end{matrix} & ( 13 )\end{matrix}$$

Noting that

$$\frac{M ( θ , τ )}{{A}_{h} ( - θ , t )} = exp [ - \frac{{t}^{2} ( 1 + {C}^{2} )}{4} ] \times exp [ - \frac{C θ t}{2} ] \times exp [ - \frac{{θ}^{2}}{4} ] , \qquad ( 14 )$$

we easily find that (9) gives the original pulse.

It should be stressed that the co 0-dependence of the sonogram and its characteristic function is cancelled out in (14), and the pulse waveform and phase , which are not dependent on ω_{0,} are retrieved. However, when 107 ₀<<1, the first term of (12) approaches to exp(−ω₀²t²). This fact means that the temporal width of the sonogram is almost determined from the inverse of the filter bandwidth, and that the intrinsic information about the original pulse is masked by it. In such a case, the accurate pulse reconstruction becomes difficult since in the third term of (13), the factor of exp(−θ²/4), which is necessary for the pulse reconstruction, is much smaller than the factor of exp(−θ²/4ω₀²), which must be cancelled out in (14). On the other hand, when ω₀>>1, |C|, we can not obtain sufficiently high spectral resolution to characterize the sonogram. Note that in the first term of (13), the factor of exp[−τ²(1+C²)/4], which is essential to the pulse reconstruction, is much smaller than the factor of exp(−τ² ω₀²/4), which must be cancelled out in (14); hence, we can no longer retrieve the pulse accurately. We, thus, find the optimum value of ω₀≅1.

### [B] Requirement for the Sampling Pulsewidth

We next consider the requirement for the sampling pulse width. Let the sampling pulse have the Gaussian intensity waveform given by

$${I}_{s} ( t ) = exp [ - \frac{{t}^{2}}{{T}_{s}^{2}} ] ; \qquad ( 15 )$$

where Ts denotes the normalized pulse width parameter of the sampling pulse. The sonogram measured in FIG. 1 is given as

Gₘ=(ω, t)=∫G(ω, τ)lₛ(T−t)dτ (16)

The characteristic function Mm(θ, τ) of the measured sonogram Gm(ω, τ) is given from (16) as

Mm(θ, τ)=M(θ. τ)Iₛ(θ)*, (17)

where T s(θ) denotes the Fourier transform of Is(t).

Using the Fourier transform of Is(t) expressed as

$${I}_{s} ( θ ) = exp [ - \frac{{T}_{s}^{2} {θ}^{2}}{4} ] ; \qquad ( 18 )$$

the characteristic function for the measured sonogram is given from (3) and (17) as

$${M}_{s} ( θ , τ ) = exp [ - \frac{{τ}^{2} ( 1 + {ω}_{0}^{2} + {C}^{2} )}{4} ] \times exp [ - \frac{C θ τ}{2} ] \times exp [ - \frac{{θ}^{2} \{ 1 + ( 1 + {T}_{s}^{2} ) {ω}_{0}^{2} \}}{4 {ω}_{0}^{2}} ] . \qquad ( 19 )$$

Then, we have

$$\frac{{M}_{s} ( θ , t )}{{A}_{h} ( - θ , t )} = exp [ - \frac{{t}^{2} ( 1 + {C}^{2} )}{4} ] \times exp [ - \frac{C θ t}{2} ] \times exp [ - \frac{( 1 + {T}_{s}^{2} ) {θ}^{2}}{4} ] . \qquad ( 20 )$$

Comparing (14) and (20), the requirement for reconstructing the pulse precisely is that Ts<<1. This means that the sampling pulse width must be much shorter than the width of the pulse under test. However, when we know the sampling pulse shape and its Fourier transform in advance, we can deconvolute the measured characteristic function by using (17). This deconvolution process is effective so long as Ts is comparable with or smaller than the pulse width under test.

One may expect that when the bandwidth of the filter becomes narrower, the sonogram can be measured more precisely because the width of the filtered pulse becomes wider than the sampling pulse width, allowing the pulse to be reconstructed. This statement is partially correct since the third term of (19) approaches to exp(−θ²/4 ω₀²) which is independent of Ts, as ω₀ tends to zero. However, as mentioned before, this term does not contain the intrinsic information about the pulse, and is cancelled out in the pulse reconstruction process as shown in (20). Therefore, it has no meaning to use a filter bandwidth too small for the sonogram measurement and the succeeding pulse reconstruction.

### [C] Sonogram Measurement Using the Pulse Under Test as the Sampling Pulse

Reid deals with pulse retrieval from the sonogram measured in the cross-correlation setup shown in FIG. 2, in which the sampling pulse is identical to the pulse under test. When the filter bandwidth is smaller than the spectral width of the pulse under test, the width of the frequency-filtered pulse usually becomes wider than the width of the pulse under test. Hence, it seems reasonable to expect that we can obtain the sonogram sufficiently accurate for pulse reconstruction. However, by following the method described in the previous subsection, we can show that pulse retrieval is not necessarily possible in this case.

The sonogram measured in FIG. 2 is given as

Gₘ(ω. t)=∫G(ω, τ)I(τ−t)dτ, (21)

where I(t)=|s(t)² is the intensity waveform of the pulse under test. Now, our problem is as follows: Can we really retrieve the pulse under test from Gm(ω, t), instead of using G(ω, t)?

The characteristic function Mm(θ, τ) of the measured sonogram Gm(ω, t) is given from (21) as

Mₘ(θ, τ)=M(θ, τ)I(θ)*, (22)

where T (θ) denotes the Fourier transform of I(t). For the Gaussian waveform given by (10), we have

$$I ( θ ) = exp [ - \frac{{θ}^{2}}{4} ] . \qquad ( 23 )$$

Substitution of (13) and (23) into (22) yields

$${M}_{m} ( θ , τ ) = exp [ - \frac{{τ}^{2} ( 1 + {ω}_{0}^{2} + {C}^{2} )}{4} ] \times exp [ - \frac{C θ τ}{2} ] \times exp [ - \frac{{θ}^{2} ( 1 + 2 {ω}_{0}^{2} )}{4 {ω}_{0}^{2}} ] . \qquad ( 24 )$$

We reconstruct the pulse from the measured sonogram Gm(ω, t). Noting that

$$\frac{{M}_{m} ( θ , t )}{{A}_{h} ( - θ , t )} = exp [ - \frac{{t}^{2} ( 1 + {C}^{2} )}{4} ] \times exp [ - \frac{C θ t}{2} ] \times exp [ - \frac{{θ}^{2}}{2} ] , \qquad ( 25 )$$

and substituting (25) into (9), we can obtain the complex amplitude of the reconstructed pulse as

$$s ( t ) = exp [ - \frac{( {C}^{2} + 3 ) {t}^{2}}{8} ( 1 + j \frac{2 C}{{C}^{2} + 3} ) ] . \qquad ( 26 )$$

This reconstructed pulse is different from the pulse under test. Even if we use the iterative algorithm for pulse reconstruction assuming that the frequency window function is unknown, the retrieved pulse should be given by (26), which differs from the pulse under test. This result also denies the statement that we can measure the sonogram sufficiently for pulse reconstruction when the filter bandwidth is smaller than the spectral width of the pulse under test. We may apparently obtain an accurate sonogram by narrowing the filter bandwidth, but the original pulse waveform and phase are not reconstructed as already explained in the previous subsection.

However, we can obtain the reconstructed pulse closer to the pulse under test, modifying the reconstruction process as follows. FIG. 3 shows the block diagram of such a process. As a first step, we use M₀(θ, τ)=Mm(74 , τ) for pulse reconstruction using (9). We next calculate I₀(t) and T₀(θ) from the reconstructed pulse s₀(t). The characteristic function is then modified as

$${M}_{1} ( θ , τ ) = \frac{{M}_{0} ( θ , τ )}{{{I}_{0} ( θ )}^{x}} . \qquad ( 27 )$$

Using the modified characteristic function M₁ and (9), we obtain the pulse s₁(t). As shown in FIG. 3, this process is repeated until the converged pulse is obtained.

We apply this modification process to the chirped Gaussian pulse. When |C|<<1, this process is very effective, and Table I shows the pulse width and chirp parameters of the reconstructed Gaussian pulse, which are normalized to the original values, as a function of the number of iteration. We find that these parameters rapidly converge at the real values. Even when we do not apply the process (the number of iteration=0), the ratio of the reconstructed pulse width to the original value is \sqrt{4/3}, and the error is as small as 15%.

However, when |C|>>1, the reconstructed pulse moves toward

$$s ( t ) = exp ( - \frac{{C}^{2} {t}^{2}}{8} - j \frac{C {t}^{2}}{4} ) . \qquad ( 28 )$$

and the actual pulse is no longer reconstructed.

We, thus, conclude that only the pulse whose chirp parameter is small enough can be reconstructed from the sonogram measured in FIG. 2.

TABLE I

| number of iteration | pulse-width parameter | chirp parameter |
|---|---|---|
| 0 | $\sqrt{\frac{4}{3}}$ | $\frac{2}{3}$ |
| 1 | $\sqrt{\frac{4}{5}}$ | $\frac{6}{5}$ |
| 2 | $\sqrt{\frac{12}{11}}$ | $\frac{10}{11}$ |

### IV. Optical Sampling System Having the Function of Sonogram Characterization

In future ultra-high-speed optical fiber communication systems employing optical time-division multiplexing (OTDM), picosecond or sub-picosecond optical pulses will be transmitted. In these systems, the dispersive effect of optical devices such as fibers for transmission and optical filters induces serious waveform distortion and chirp of transmitted pulses.

In order to diagnose the intensity waveform of such optical pulses, the optical sampling system is the most powerful tool, provided that we can prepare a sampling pulse, which has a width narrower than that of the pulse under test and is highly-synchronized with the pulse under test.

On the other hand, there is strong demand for chirp measurement of optical pulses, and one of the methods to meet this demand is the sonogram characterization of optical pulses. In all of the previous reports, after a pulse under test is frequency-filtered, the intensity waveform of the filtered pulse, which is called the sonogram, is measured by cross-correlating the filtered pulse with the original pulse under test. However, the actual sonogram cannot be obtained by this method, because the temporal resolution is limited by the shape of the pulse under test. One the contrary, when a short sampling pulse synchronized with the pulse under test is available, as is the case of the optical sampling system, we can realize precise sonogram characterization of the pulse under test by using the sampling pulse.

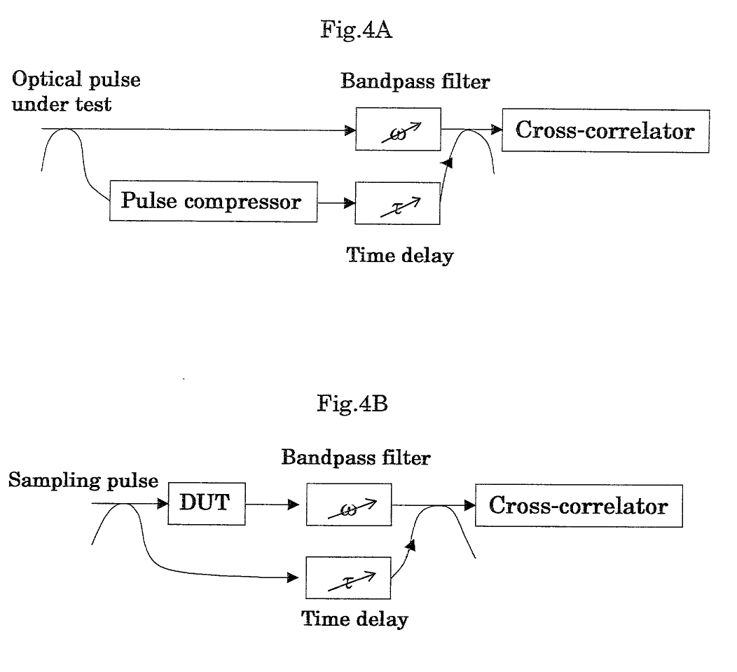

Provided that the sonogram is measured by using experimental setup shown in FIG. 4A, and that the sampling pulse width is much shorter than that of the pulse under test, we can measure the sonogram precisely. The pulse under test is completely retrieved from the measured sonogram by using (9).

This experimental setup is regarded as an optical sampling system including the function of sonogram characterization, and can easily produce the following modified versions. In FIG. 4A, the sampling pulse is obtained by compressing the pulse under test itself. In FIG. 4B, the ultrashort sampling pulse is incident on an optical device under test (DUT). Since the sonogram of the broadened output pulse is measured by cross-correlation using the sampling pulse, we can determine the impulse response of the DUT.

### V. Optical Sampling System AT 1.55. μm for the Measurement of Pulse Waveform and Phase Employing Sonogram Characterization

Practical implementation of such an optical sampling system at 1.55 μm having the sonogram characterization function will be described. We demonstrate the measurement of impulse response of an optical bandpass filter as a specific application of the system. In the experimental setup, we first prepare a 200-fs optical pulse. Such pulse is incident on an optical bandpass filter under test, and the sonogram of the output pulse is measured by a highly-sensitive optical cross-correlator using two-photon absorption (TPA) in a Si avalanche photodiode (APD). The 200-fs pulse is used as a sampling pulse in the cross-correlator. The intensity and phase of the output pulse are very rapidly reconstructed from the sonogram by using a newly derived pulse reconstruction formula, enabling us to characterize the impulse response of the filter.

### [A] Sonogram Measurement

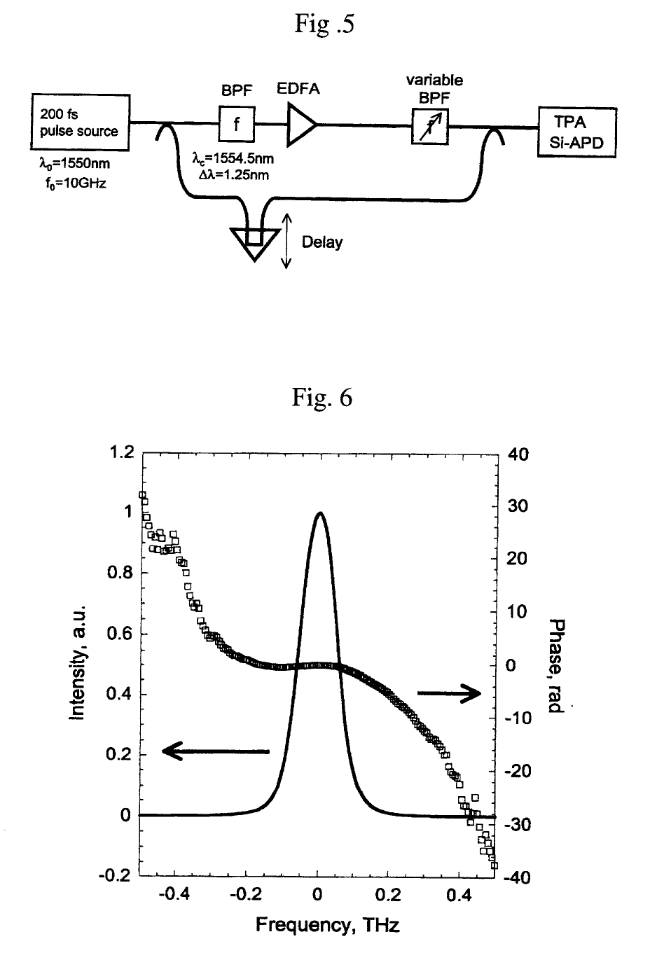

FIG. 5 shows the experimental setup. A Fourier-transform-limited 200-fs pulse having a 10-GHz repetition rate, a center wavelength of 1550 nm, and a spectral width of 20.6 nm was obtained by supercontinuum compression of a mode-locked semiconductor-laser pulse. This pulse was branched into two paths. In one of the paths, an adjustable time delay was inserted, and the output from this paths was used as a sampling pulse was −10 dBm. In the other path, a three-cavity optical bandpass filter under test was inserted. The center wavelength of the filter was 1554.5 nm and the 3-dB bandwidth was 1.25 nm. The output pulse was amplified up to the average power of 10 dBm, and incident on a tunable bandpass filter (BPF) with a 1-nm bandwidth for frequency gating. FIG. 6 shows the measured intensity and phase responses of the filter. The sampling pulse and the frequency-filtered pulse were combined and led to a cross-correlator using two-photon absorption in a Si APD.

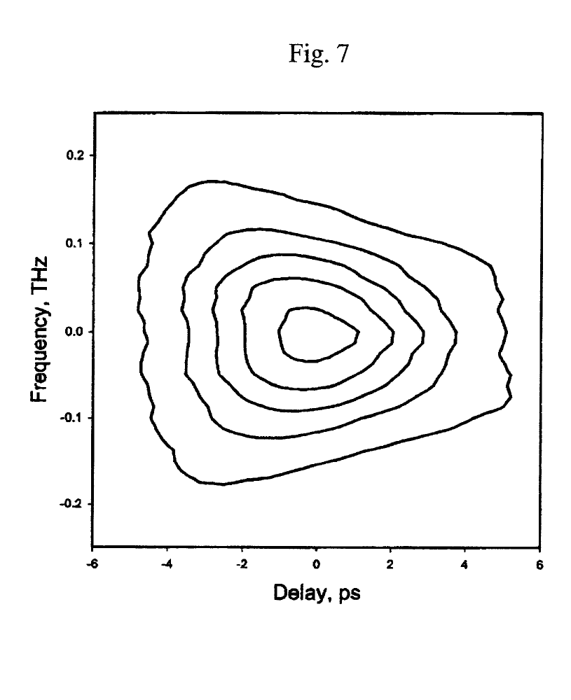

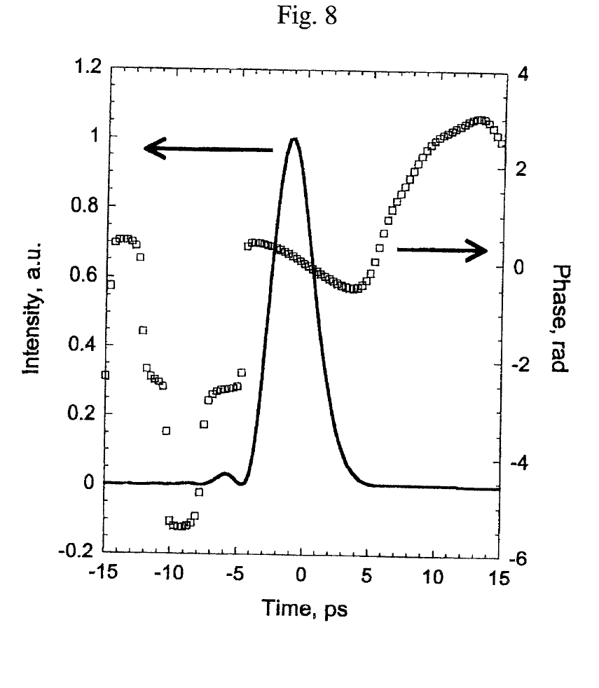

The sonogram trace was measured by sweeping the center frequency of the frequency gate and the delay time. The data points taken in such measurement were 256 ×256. FIG. 7 shows the measured sonogram trace. Solid curves represent contours, where the normalized intensity is 0.2, 0.4, 0.6, 0.8 and 1.

### [B] Pulse Reconstruction Process

We first derive a pulse reconstruction formula from the sonogram closely following the method given by L. Cohen, “Time-frequency distributions—A review,” Proc. IEEE, vol. 77, no.7, pp. 941-981, 1989. Let the complex amplitude of the signal pulse under test be S(θ) in the frequency domain and the complex transfer function of the filter be H(θ). When the center frequency of the filter is ω, the sonogram P(t, ω) is given as

P(t, ω)=|∫S(θ)H(θ−ω)e^{jθt}dθ|² . (29)

The signal pulse under test in the frequency domain can be obtained from the following formula:

$$S ( θ ) ∝ {( [ \int \frac{M ( θ , τ )}{{A}_{H} ( θ , - τ )} {ⅇ}^{- j \frac{θ}{2} τ} ⅆ τ ] )}^{*} , \qquad ( 30 )$$

where the M(θ, τ) and A_{H}(74 , τ) are defined as

M(θ, τ)≡∫∫P(t, ω)e^{jθe+jτω}dtdw, (31)

and

$${A}_{H} ( θ , τ ) ≡ \int {H}^{*} ( ω + \frac{θ}{2} ) H ( ω - \frac{θ}{2} ) {ⅇ}^{jωτ} ⅆ ω . \qquad ( 32 )$$

If the transfer function of the filter A_{H}(θ, τ) is known, the signal pulse under test can be reconstructed from the measured sonogram P(t, ω) using Eq.(30) without iterative calculations. The signal pulse in the time domain can be obtained with the inverse Fourier transformation of S(θ). Note that time-consuming iterative calculations have been indispensable for pulse reconstruction from the sonogram in the algorithm proposed in Reid.

The pulse output from the filter under test was reconstructed from the measured sonogram (FIG. 7) and the transfer function of the filter (FIG. 6) by using Eq.(30). FIG. 4 shows the intensity waveform and phase of the reconstructed pulse. Since iterative calculations are not necessary, computation time for pulse reconstruction was shorter than 1 s, assuming a base 800 MHz Pentium®III.

The intensity waveform has an oscillatory structure in the leading edge. On the other hand, the phase response in the leading edge has abrupt π-rad shifts when the intensity becomes zero. These characteristics clearly show the effect of the negative dispersion slope (β₃<0) of the bandpass filter.

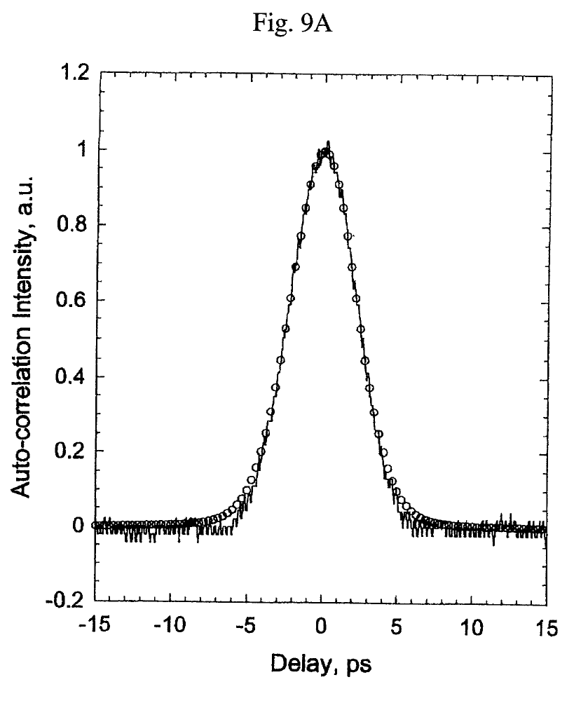

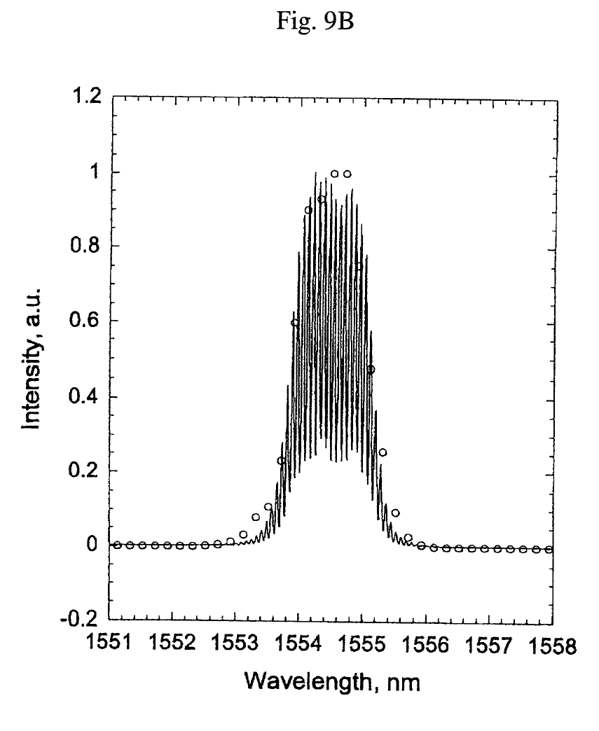

The auto-correlation trace calculated from the reconstructed pulse is shown in FIG. 9A by circles, whereas the solid curve in FIG. 9B is the directly measured one. Agreement between them is very good. On the other hand, the spectrum calculated from the reconstructed pulse is shown in FIG. 9B by circles. The solid curve represents the directly measured spectrum, where the fine structures corresponds to the 10-GHz repetition rate of the pulse train. The spectrum of the single pulse is given by its envelope, which is in good agreement with the circles. From these results, we find that the signal pulse is precisely reconstructed from its sonogram.

We have constructed an optical sampling system at 1.55 μm which enables us to measure the pulse waveform and phase through sonogram characterization. The measurement of impulse response of an optical bandpass filter is actually demonstrated by using this system. In our system, a 200-fs optical pulse is incident on an optical bandpass filter under test. The sonogram of the output pulse is measured by an optical cross-correlator using two-photon absorption in a Si avalanche photodiode, in which the 200-fs pulse is also used as a sampling pulse. The intensity and phase of the output pulse are very rapidly reconstructed from the sonogram by using a newly derived pulse reconstruction formula. The measured intensity and phase responses clearly show the effect of the negative dispersion slope of the filter.

While the preferred embodiment of the invention has been illustrated and described, it will be appreciated that various changes can be made therein without departing from the spirit and scope of the invention.

What is claimed is:

1. A method for measuring an optical pulse comprising:
(a) filtering an optical pulse to obtain a frequency-filtered pulse, a transfer function for said frequency filtering being given;
(b) measuring a sonogram , which is defined as the intensity waveform of said frequency-filtered pulse, to obtain a measured sonogram; and
(c) reconstructing said optical pulse by using said measured sonogram and said transfer function.

2. The method as claimed in claim 1, said method including an optical pulse to be measured and a sampling pulse for cross-correlation with said optical pulse.

3. The method as claimed in claim 2, wherein the pulse width of said sampling pulse is much shorter than the pulse width of said optical pulse.

4. The method as claimed in claim 1, wherein the optical pulse is reconstructed by a predetermined formula, and said formula is given by the following:
$$s ( t ) = \frac{1}{2 π {s}^{*} ( 0 )} \int \frac{M ( θ , t )}{{A}_{h} ( - θ , t )} exp ( - jθ t / 2 ) ⅆ θ$$
where s(t) is the complex amplitude of said pulse, M(θ, t) is the characteristic function of the sonogram, and Aₕ(−θ, t) is the ambiguity function derived from the transfer function of the filter.

5. The method as claimed in claim 4, wherein said formula is derived form the following equations:
$$\begin{matrix}M ( θ , τ ) = \int \int G ( ω , t ) exp ( jθ t + jτω ) ⅆ t ⅆ ω ; \\ h ( t ) = \frac{1}{\sqrt{2 π}} \int H ( ω ) exp ( jω t ) ⅆ ω ; and \\ A h ( θ , τ ) = \int {h}^{*} ( t - \frac{1}{2} τ ) h ( t + \frac{1}{2} τ ) exp ( jθ t ) ⅆ t\end{matrix}$$
where M(θ, τ) is the characteristic function of the sonogram G(θ, t), h(t) is the inverse Fourier transform of the transfer function of the filter H(ω), and Aₕ(θ, τ) is the ambiguity function of h(t).

6. The method as claimed in claim 4, said method including an optical pulse to be measured and a sampling pulse, which is same as said optical pulse, for cross-correlation with said optical pulse; and
said method further comprising the steps of:
(a) reconstructing the optical pulse using said formula to obtain a reconstructed pulse;
(b) modifying said characteristic function of the sonogram by using said reconstructed pulse; and
(c) repeating said reconstructing and modifying until a converged pulse is obtained.

7. An optical sampling system employing the method as claimed in claim 1.

8. The optical sampling system as claimed in claim 7, said system comprising:
(a) a first path for optical pulse under test, said first path having a bandpass filter, said optical pulse under test being frequency-filtered by said bandpass filter to produce a frequency-filtered pulse;
(b) a second path for sampling pulse, said second path having a pulse compressor and a time delay, said sampling pulse being obtained by compressing said optical pulse under test; and
(c) a cross-correlator for said frequency-filtered pulse and said sampling pulse.

9. The optical sampling system as claimed in claim 7, said system comprising:
(a) a first path having a device under test (DUT) and a bandpass filter, a sampling pulse being incident on said DUT, said incident optical pulse being frequency-filtered by said bandpass filter to produce a frequency-filtered pulse;
(b) a second path for sampling pulse, said second path having a time delay; and
(c) a cross-correlator for said frequency-filtered pulse and said sampling pulse.

10. The optical sampling system as claimed in claim 9, wherein the impulse response of said DUT is characterized from the sonogram.

11. The optical sampling system as claimed in claim 10, wherein said DUT is an optical bandpass filter.
